(19) United States
(12) Patent Application Publication
(10) Pub. No.: US 2010/0275450 A1
(43) Pub. Date: Nov. 4, 2010

(54) HAND OPERATED POWER TOOL

(76) Inventor: Neil Refson, Kintore (GB)

Correspondence Address: WINSTEAD PC, P.O. BOX 50784, DALLAS, TX, 75201, US

(21) Appl. No.: 12/682,366

(22) PCT Filed: Aug. 27, 2008
(86) PCT No.: PCT/GB2008/050741

§ 371 Date: Jul. 14, 2010

(30) Foreign Application Priority Data
Oct. 11, 2007 (GB) 0719881.5

(51) Int. Cl. B26B 29/06

(52) U.S. Cl. 30/286

(57) ABSTRACT

A hand operated power tool (10) comprises a housing having front and rear ends (14,16), a cutting element (20) provided towards the front end of the housing and a motor mounted within the housing, a main axis of the motor lying substantially in the plane of the cutting element, and a guard (22) mounted for movement relative to the housing between a safety position enclosing the cutting element and a cutting position in which the cutting element protrudes from the guard, wherein the guard is pivotally coupled to the housing towards the rear end of the housing.

The present invention relates to a hand operated power tool. In particular, but not exclusively, the present invention relates to a hand operated power tool of a type having a cutting element and a guard mounted for movement between a safety position where the guard encloses the cutting element, and a cutting position where the cutting element protrudes from the guard.

Many different hand operated power tools, having cutting elements of various different types, are known. These include saws such as circular saws and jigsaws, planers and sanders.

One particular type of saw is the plunge-type circular saw, developed by the present Applicant, and disclosed in European Patent Publication No. 0788421. The saw of EP0788421 has a cutting element in the form of a relatively small circular blade, which is mounted in an operating head of the saw and disposed, in use, perpendicularly to a surface to be cut. A guard is mounted around the operating head of the tool, and is biased towards a position in which the blade is enclosed. A motor is mounted in a handle which is inclined relative to a base plate of the guard, for driving the blade. In use, an operator locates the base plate of the guard in abutment with a surface of a workpiece to be cut, and presses down on the tool to expose the blade from the guard, thereby plunging the blade into the surface. When the force on the blade is released, the guard is returned under the biasing action to the position where the blade is enclosed. The guard is mounted on the operating head such that, during passage between the position in which the blade is enclosed and the position in which the blade is exposed, the base plate moves at a constant angle relative to the handle containing the motor. This offers numerous advantages in operation of the saw, and permits the operator to carry out complex cuts which were not possible prior to development of the Applicant's saw.

Whilst the plunge-type saw disclosed in EP0788421 offers significant advantages over circular saws known prior to development of the plunge-saw, the guard must be carefully mounted on the cutting head of the saw in order to permit the desired movement of the guard, with the base plate at a constant angle relative to the handle.

Since development and commercialisation of the Applicant's plunge-saw, disclosed in EP0788421, other plunge-type saws have come on to the market. These saws typically have a guard/base plate which is pivotally coupled to a housing of the saw, usually at the rear of the blade and close to one edge of the guard/base plate, either within the boundaries of the guard/plate plate, or adjacent to the edge. Such saws suffer from the significant disadvantage that the handle of the saw changes angle significantly in use, between starting of a plunge cut and reaching a maximum desired cutting depth. Typically, this variation in angle will be 30 degrees or more. As a consequence, when starting a cut, the hand and forearm of an operator will be fairly close to the horizontal and behind the saw blade. In this position, the operator has minimal control over the saw, yet maximum control is needed at this point of the cutting operation, when the blade enters a workpiece surface in which a cut is to be formed.

Accordingly, in order to ensure sufficient control, it has been found that the operator has to use his other hand to hold the tool in a more forward position. On larger saws, a second handle may be provided for this purpose, adding to the size and weight of the saw. Additionally, a requirement to hold the saw with two hands prevents the operator from being able to hold the workpiece during cutting. As a result, it is typically necessary to clamp the workpiece in order that a cutting operation may be safely carried out, which is time-consuming. Other, smaller saws do not permit for such a second handle to be provided, which can seriously affect performance and safe operation of the saw.

It is amongst the objects of embodiments of the present invention to obviate or mitigate at least one of the foregoing disadvantages.

A hand operated power tool comprising:

a housing having front and rear ends;
a handle on the housing, the handle having a grip portion disposed between the front and rear ends of the housing;
a cutting element provided towards the front end of the housing; and a motor mounted within the housing, a main axis of the motor lying substantially in the plane of the cutting element, and
a guard mounted for movement relative to the housing between a safety position enclosing the cutting element and a cutting position in which the cutting element protrudes from the guard;
wherein the guard is pivotally coupled to the housing, and wherein a point about which the guard pivots relative to the housing is positioned rearwardly of the handle grip portion.

Providing a power tool with a guard that is pivotally coupled to a housing of the tool, and wherein a point about which the guard pivots relative to the housing is positioned rearwardly of the handle grip portion, offers significant improvements in operation of the tool of the present invention when compared to prior tools. In particular, providing the pivot point rearwardly of the handle grip portion enables an angle through which the guard moves, relative to the housing, to be minimised (compared to prior tools). This in turn facilitates operation of the tool, by avoiding or minimising the extent to which the hand and forearm of the operator must be close to the horizontal and behind the cutting element as a cutting operation is commenced. This provides the operator with enhanced control, particularly at the point the cutting element enters a workpiece surface.

Mounting the motor within the housing, and more preferably within the handle, with a main axis of the motor lying substantially in the plane of the cutting element, results in a lesser change in the handle angle when the tool is plunged into a workpiece than known tools. This improves the safety of the tool.

The guard may be coupled to the housing by an at least one connector, which may be elongate, and which may be an arm, link, finger or the like. Preferably, the guard is connected to the housing by two connectors, to provide the guard with a degree of torsional stiffness in its movement relative to the housing. The connector may be formed integrally with the guard, or may be provided as a separate component coupled to the guard.

The tool may comprise a mounting portion extending from the housing, and which may be formed integrally with the housing or as a separate component coupled to the housing. The guard, in particular by at least one connector, may be pivotally coupled to the mounting portion and thereby pivotally coupled to the housing. The mounting portion may thereby define the point about which the guard pivots relative to the housing. The mounting portion may be shaped such that the pivot point is spaced a sufficient distance from the housing so as to define a space between the guard, in particular by at least one connector, and the housing, the space being for receiving digits of the operator. This may facilitate gripping of the tool by an operator without the digits of the operator coming into contact with the guard/connector.

The guard may also be slidably coupled to the housing, to facilitate movement of the guard generally in a direction parallel to an axis extending from the front end to the back end of the tool. This may facilitate translation of the guard with respect to the housing in the direction parallel to the tool axis, during pivoting of the guard about the housing as the guard is moved between the safety and cutting positions. This, in turn, may facilitate operation of the tool by restricting movement of the guard relative to an operating head of the tool, in which the cutting element is housed. This is because permitting such sliding movement of the guard allows the position of the pivot point to vary. In contrast, where the guard is coupled to the housing at a fixed pivot point, a spacing between front and back walls of the guard varies as the guard is moved between the safety and cutting positions.

In embodiments of the invention, the housing may comprise an elongate mounting aperture, slot, channel or the like by which the guard, in particular by at least one connector, is slidably coupled to the housing. The aperture may be defined by the mounting portion. The aperture may have an aperture axis, and the aperture axis may extend parallel to a main axis of the housing. However, in alternative embodiments, the aperture axis may be inclined relative to the housing axis, or the aperture may be arcuate such that the aperture axis lies on a curve.

The guard and/or the at least one connector may be shaped such that a space is defined between the guard/connector and the housing, the space being for receiving digits of the operator. The or at least one connector may be comprised of at least two portions disposed at non-parallel angles with respect to one-another, to thereby define the space. However, in alternative embodiments, the at least one connector may be curved.

The guard may be coupled to the housing such that during movement of the guard between the safety and cutting positions, an angle of the guard, in particular a base plate of the guard, remains substantially constant. This may facilitate operation of the tool by reducing or preventing or at least restricting movement of the guard in the direction parallel to the axis of the tool during movement of the guard between said positions. In an embodiment of the invention, the or at least one connector is pivotally coupled at a first end to the guard and at a second opposite end to the housing.

The housing may be generally elongate, housing a motor for driving the cutting element and defining the handle. Accordingly, the grip portion may be formed on a part of the housing shaped to house the motor. Alternatively, the housing may comprise a portion housing a motor for driving the cutting element, and a separate portion defining the handle.

It will be understood that the grip portion of the handle is that portion of the handle shaped or otherwise adapted to be gripped by an operator. The tool may comprise an activating switch or trigger, and the switch may be provided adjacent or within the grip portion.

The tool may be a saw, in particular a plunge-saw, having a cutting element in the form of a circular blade. However, in alternative embodiments, the tool may be a planer having a planer blade. Indeed, it will be understood that the principles of the present invention may be applied to a wide range of different types of tools including alternative saws, such as jigsaws, and sanders.

It will be understood that references herein to the guard enclosing the cutting element, when in the safety position, are to the guard being positioned so as to prevent an operator from harm in the event that the tool is inadvertently activated. Accordingly, references to the guard enclosing the cutting element should be understood to mean that the guard sufficiently restricts access to the cutting element such that a user may not come to harm in the event of unintentional activation. Thus, for example, the guard may comprise a base plate having an aperture therein through which the cutting element protrudes when the guard is in the cutting position; the dimensions of the aperture may be selected such that a digit of a user may not pass through the aperture.

Additionally, it will be understood that the guard is pivotally coupled to the housing at a point positioned rearwardly of the handle grip portion in that the point is behind the grip portion taken: in a direction along an axis of the tool extending from the front end of the housing to the rear end; and/or in a direction along a main axis of a part of the tool such as the tool housing; and/or in a direction extending from the front end of the tool parallel to a cut to be made and/or in a plane of a surface in which a cut is to be formed.

The tool may comprise a depth adjuster for governing the extent to which the cutting element protrudes through the guard when the guard is in the cutting position, and thus governing a depth of cut which may be formed in a surface of a workpiece using the tool.

According to a second aspect of the present invention, there is provided a hand operated power tool comprising:

a housing having front and rear ends;
a cutting element provided towards the front end of the housing; and a motor mounted within the housing, a main axis of the motor lying substantially in the plane of the cutting element, and
a guard mounted for movement relative to the housing between a safety position enclosing the cutting element and a cutting position in which the cutting element protrudes from the guard;
wherein the guard is pivotally coupled to the housing towards the rear end of the housing.

According to a third aspect of the present invention, there is provided a hand operated power tool comprising:

a housing having front and rear ends; and
a cutting element,
and a motor mounted within the housing, a main axis of the motor lying substantially in the plane of the cutting element,
a guard mounted for movement relative to the housing between a safety position enclosing the cutting element and a cutting position in which the cutting element protrudes from the guard;
wherein the guard is pivotally coupled to the housing, and wherein a distance between the cutting element and the point about which the guard pivots relative to the housing is maximised.

According to a fourth aspect of the present invention there is provided a guard for a power tool, the guard being adapted to be mounted for movement relative to a housing of a power tool between a safety position enclosing a cutting element of the tool and a cutting position in which the cutting element protrudes from the guard;

and wherein the guard is adapted to be pivotally coupled to the tool housing;
and further wherein a point about which the guard is adapted to pivot relative to the housing is positioned rearwardly of a grip portion on a handle of the tool.

Embodiments of the present invention will now be described, by way of example only, in which:

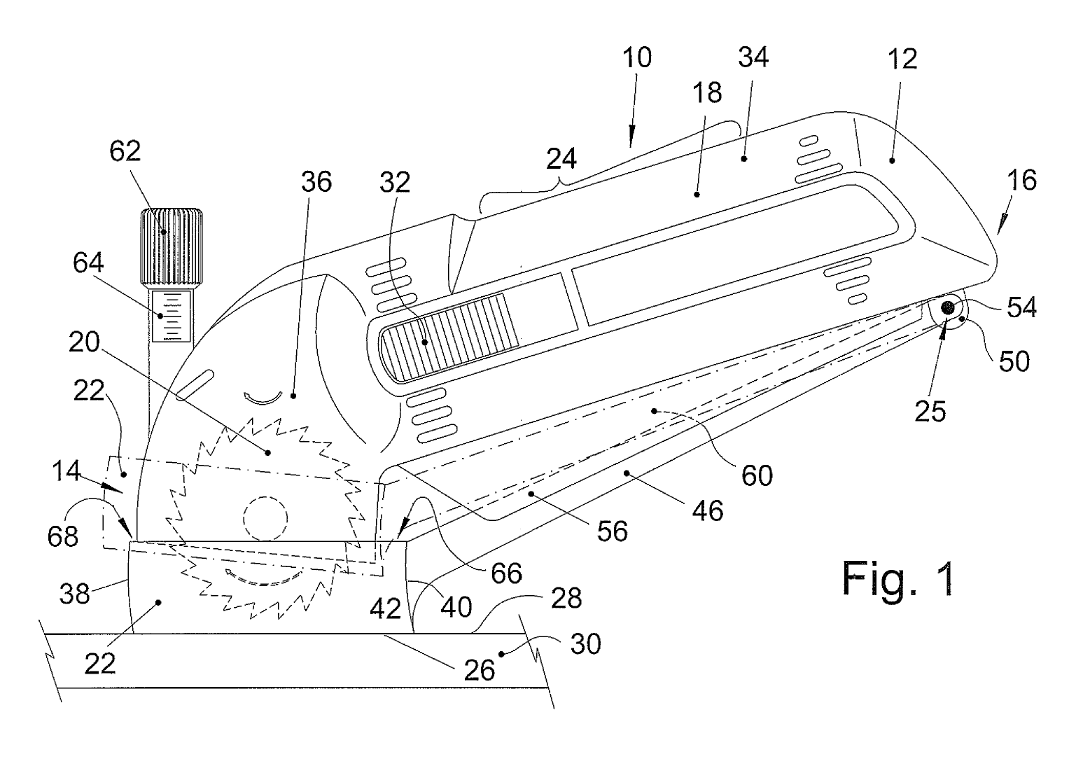

FIG. 1 is a left side view of a power tool in the form of a saw in accordance with an embodiment of the present invention;

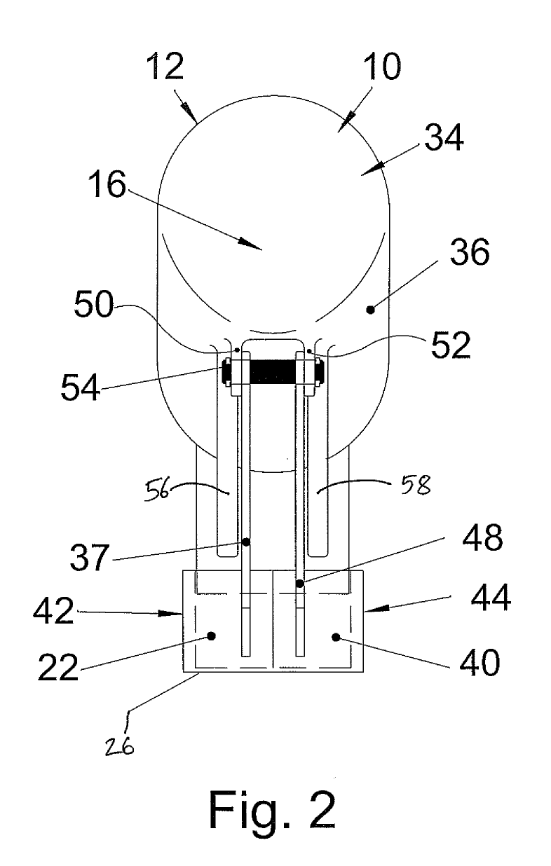

FIG. 2 is a rear view of the saw of FIG. 1;

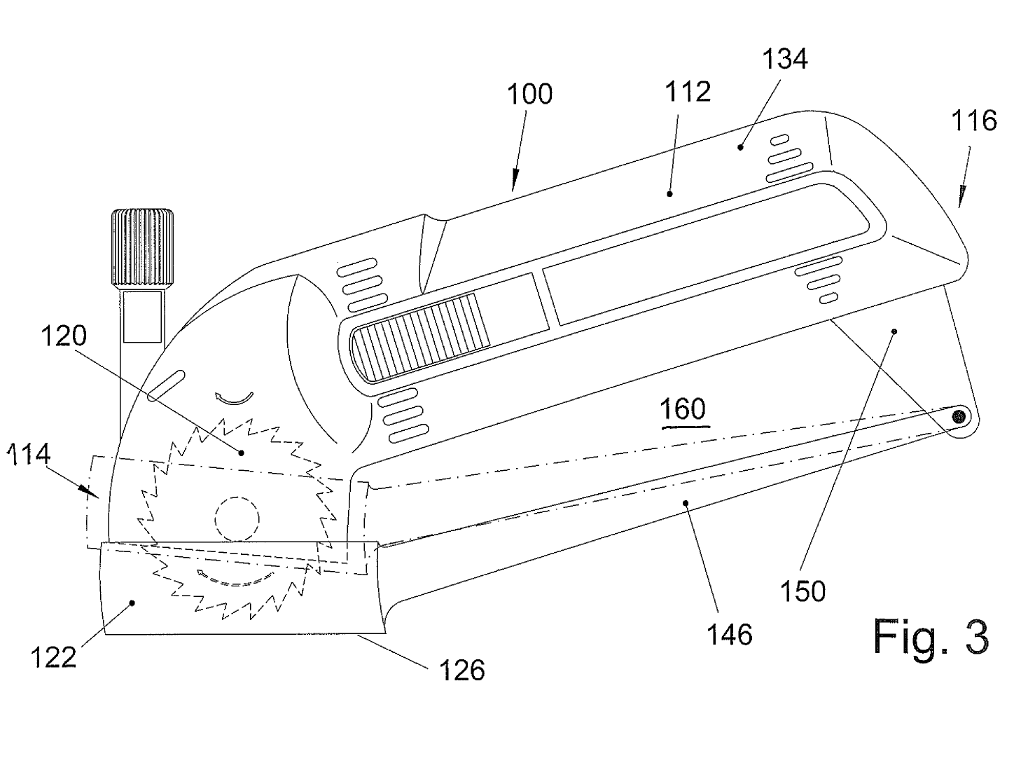

FIG. 3 is a left side view of a power tool in the form of a saw in accordance with an alternative embodiment of the present invention;

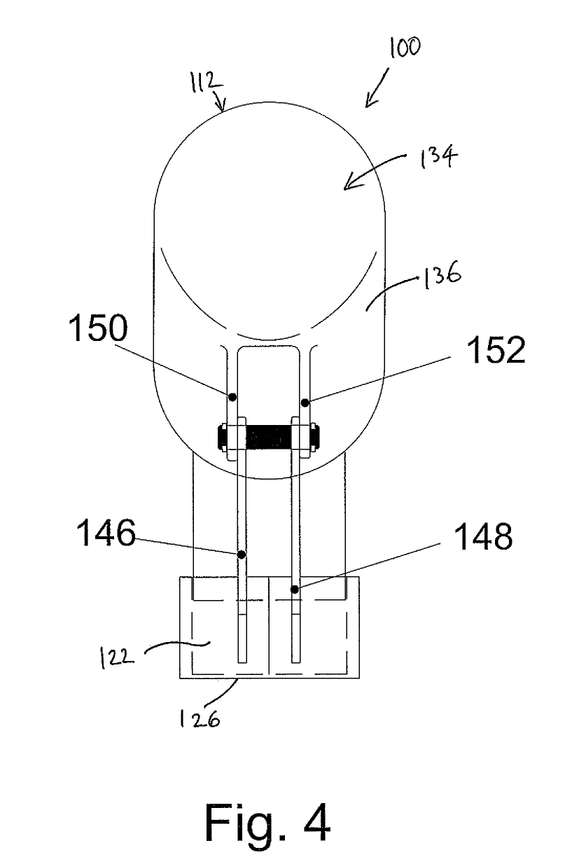

FIG. 4 is a rear view of the saw of FIG. 3;

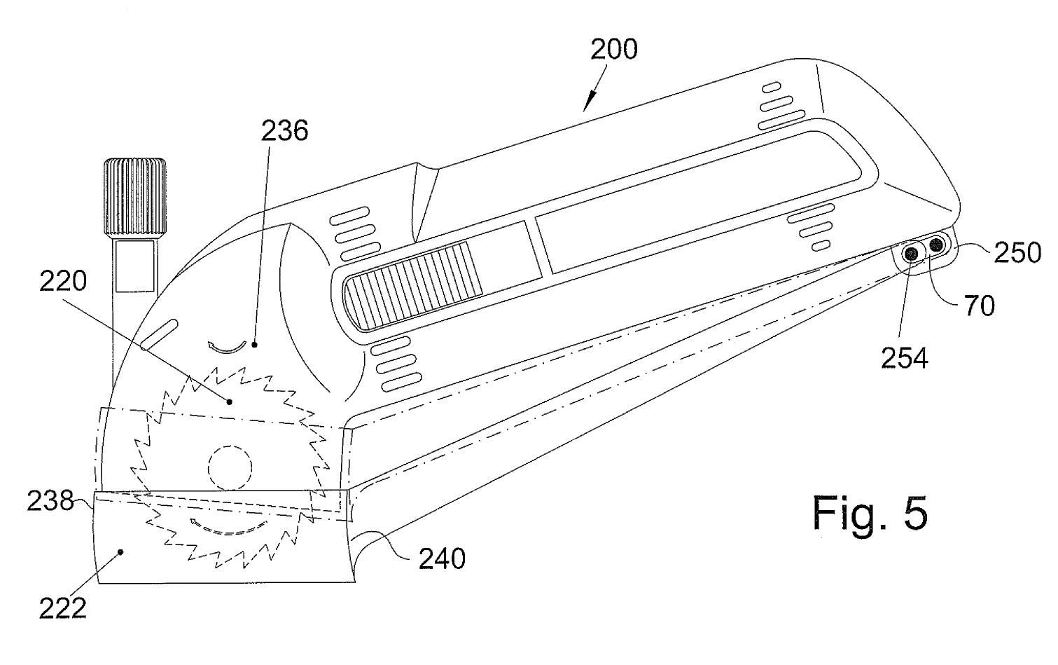

FIG. 5 is a left side view of a power tool in the form of a saw in accordance with a further alternative embodiment of the present invention;

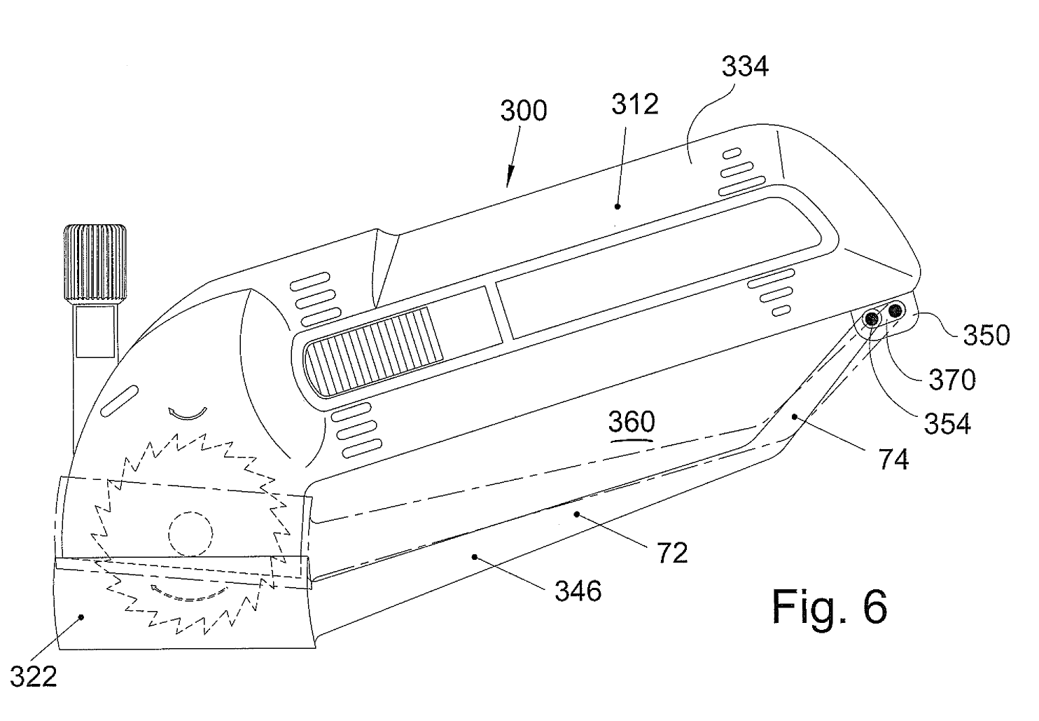

FIG. 6 is a left side view of a power tool in the form of a saw in accordance with a still further alternative embodiment of the present invention;

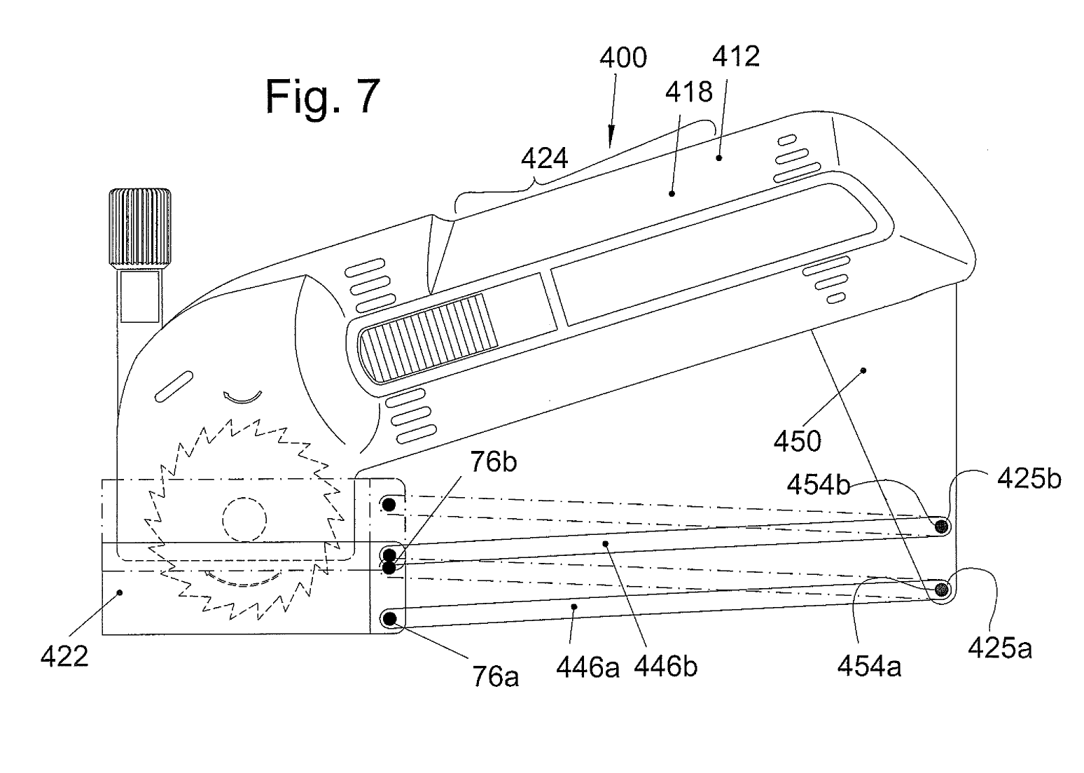

FIG. 7 is a left side view of a power tool in the form of a saw in accordance with a yet further alternative embodiment of the present invention;

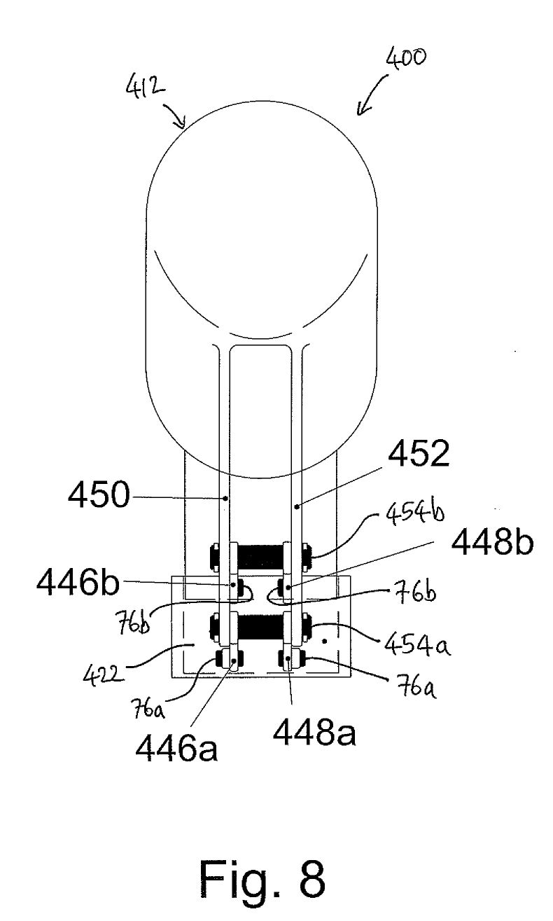

FIG. 8 is a rear view of the saw of FIG. 7;

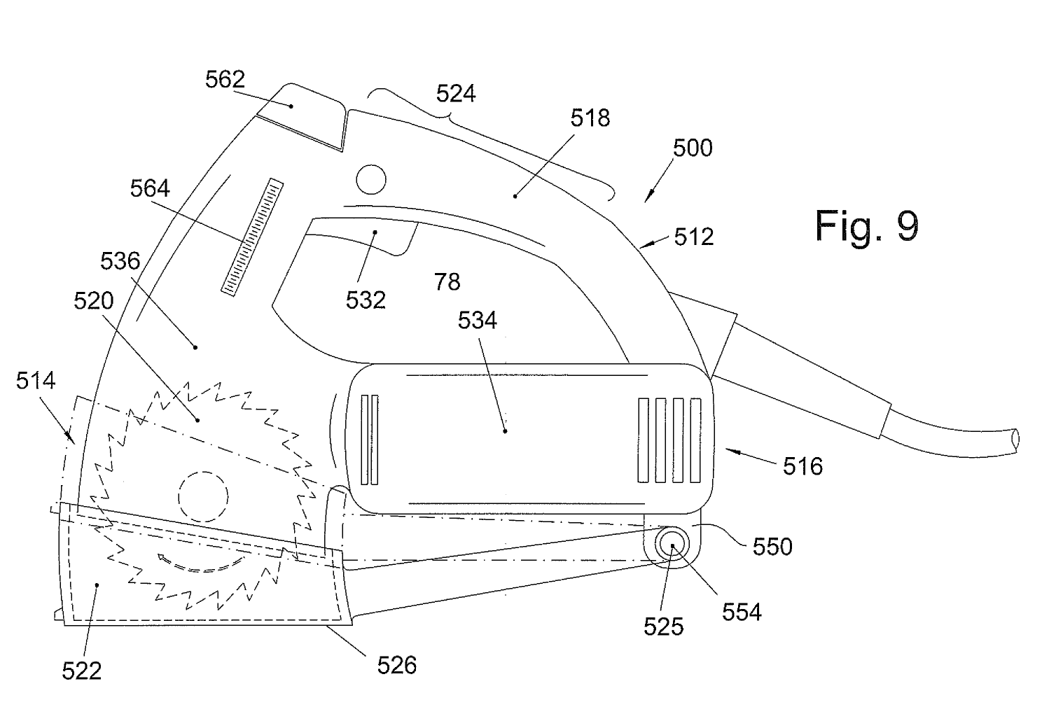

FIG. 9 is a left side view of a power tool in the form of a saw in accordance with a yet further alternative embodiment of the present invention; and

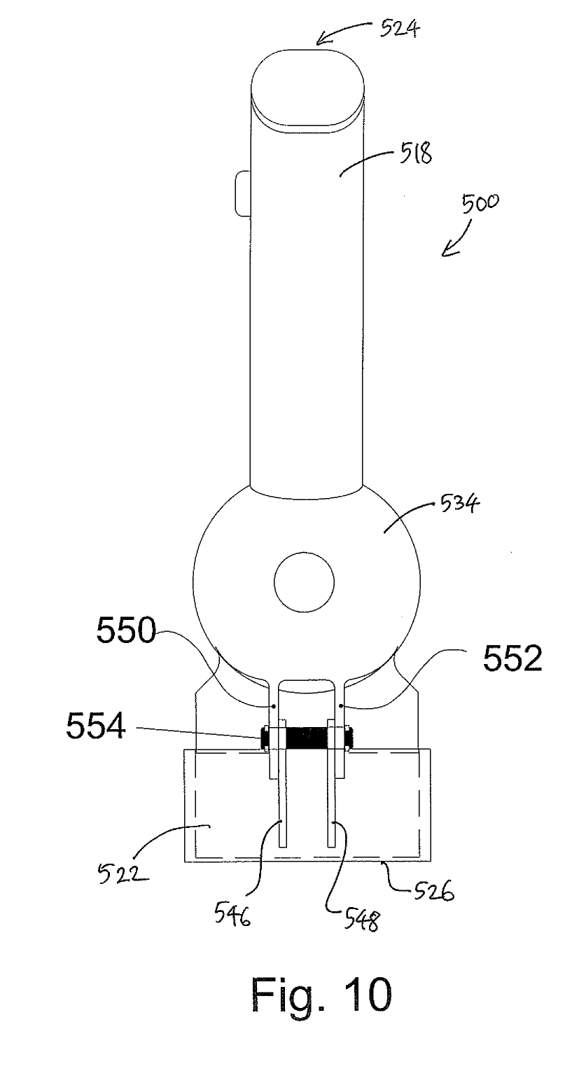

FIG. 10 is a rear view of the saw of FIG. 9.

Turning firstly to FIG. 1, there is shown a left side view of a power tool in the form of a saw in accordance with an embodiment of the present invention, the saw indicated generally by reference numeral 10. References herein to the left and right sides of the tools shown in the drawings assume viewing of the tools from the rear. The saw 10 is also shown in FIG. 2, which is a rear view of the saw.

The saw 10 generally comprises a housing having front and rear ends 14 and 16, a handle 18 on the housing 10, a cutting element in the form of a circular blade 20 provided towards the front end 14 of the housing 10, and a guard 22. The handle 18 has a grip portion 24 which is disposed between the front and rear ends 14, 16 of the housing 10. Also, the guard 22 is mounted for movement relative to the housing 10 between a safety position enclosing the blade 20 (shown in full outline in FIG. 1), and a cutting position in which the blade 20 protrudes from the guard 22 (shown in broken outline in FIG. 1). The guard 22 is biased towards the safety position such that, in the absence of an external applied force, the guard 22 will reside in the safety position. To permit movement of the guard 22 between the safety and cutting positions, the guard 22 is pivotally coupled to the housing 10, and a point 25 about which the guard 22 pivots relative to the housing 10 is positioned rearwardly of the handle grip portion 24.

In use of the saw 10, an operator grasps the saw by the grip portion 24, and positions the saw 10 with a base plate 26 of the guard 22 in abutment with a surface 28 of a workpiece 30 in which a cut is to be formed. The guard 22 is initially in the safety position, enclosing the blade 20, as shown in solid outline in FIG. 1. The operator then aligns the saw 10 appropriately with markings on the workpiece surface 28 indicating a cut to be made, activates the saw using a switch 32 to drive and rotate the blade 20, and then presses down on the saw 10. This urges the rotating blade 20 down against the biasing force of the guard 22, moving the blade 20 through a slot (not shown) in the base plate 26 of the guard 22. The blade 20 is thus urged downwardly, exposing the blade from the guard 22, and driving the blade into the surface 28, to form a desired cut.

In accordance with the teachings of the Applicant's earlier European Patent Publication Nos. 0788421 and 1177868, the blade 20 may then be driven forward to form a cut of a desired length. On completion of the cut, the saw 10 is lifted up from the workpiece surface 28, and the biasing force acting on the guard 22 returns the guard to the safety position as the saw is lifted, enclosing the blade 20 and thus protecting the operator from harm.

Providing the saw 10 with a guard 22 that is pivotally coupled to the housing 12, and wherein the point 25 about which the guard 22 pivots relative to the housing 12 is positioned rearwardly of the handle grip portion 24, offers significant improvements in operation of the saw 10 when compared to prior tools. In particular, providing the pivot point 25 rearwardly of the handle grip portion 24 enables an angle through which the guard 22 moves, relative to the housing 12, to be minimised. Indeed, in the illustrated example, the housing 12 only rotates approximately five degrees during plunging of the blade 20. This in turn facilitates operation of the saw 10, by avoiding or minimising the extent to which the hand and forearm of the operator must be close to the horizontal, and behind the saw blade 20, as a cutting operation is commenced. This provides the operator with enhanced control, particularly at the point the blade 20 enters the workpiece surface 28.

The saw 10 and its method of operation will now be described in more detail.

The housing 12 is generally elongate, and includes a portion 34 housing an electric motor (not shown) for driving the blade 20 through a suitable gearbox (also not shown), and a cutting head 36. A main axis of the motor lies substantially in the plane of the cutting element. The cutting head 36 is disposed at an angle relative to the motor housing portion 34, and defines the front end 14 of the saw 10, whilst the motor housing portion 34 defines the rear end 16. The guard 22 is generally hollow, having front and rear faces or walls 38, 40 and left and right side faces or walls 42, 44. Together, the front, rear, left side and right side faces 38, 40, 42 and 44 define a shield which fits over the operating head 36 of the saw 10, and which encloses the blade 20 when the guard is in the safety position. Thus the blade 20 is contained within the guard 22 when in the safety position.

Two elongate connectors in the form of left and right arms 46 and 48 extend from the guard 22, and are pivotally coupled to the motor housing portion 34, towards the rear end 16 of the saw 10. A pair of apertured brackets 50 and 52 are provided on the motor housing portion 34, and the left and right arms 46 and 48 are coupled to the brackets 50 and 52, respectively, using a suitable pivot pin 54. In this fashion, the guard 22 is mounted for pivoting movement relative to the housing 12, to facilitate movement between the safety and cutting positions. The guard 22 is biased towards the safety position by a torsion spring mounted on the pivot pin 50 and acting on the arms 46 and 48 (not shown), by coil or like springs acting on an internal surface of the base plate 26 (also not shown), or a combination thereof.

Left and right Finger guards or shields 56 and 58 are provided on either side of the motor housing portion 34, and prevent passage of fingers of the operator into the space 60 defined between the arms 46, 48 and the motor housing portion 34. Accordingly, this prevents the fingers of the operator from being contacted by the arms 46 and 48 when the tool is depressed and the space 60 closed, as indicated by the broken outline of the guard 22 and arms 46, 48 in FIG. 1.

The saw 10 also includes a depth adjuster mechanism including a depth adjuster knob 62, which is rotated to vary the extent to which the blade 20 may extend from the guard when the saw 10 is depressed, a reading of the depth selected being given on a depth adjuster scale 64. The mechanism employed is similar to that provided on the Applicant's prior tools, as taught by EP0788421 and EP1177868, and the blade 20 is shown at its maximum depth of cut in broken outline in FIG. 1. In addition and as taught in EP0788421 and EP1177868, the guard 22 may carry markings (not shown) to provide an indication of the positions at which the blade 20 arc intersects with the base plate 26, such that the operator may accurately judge where to position the saw 10 for commencing a cut, and how far to advance the saw 10 along the surface 28. Pointers may also be provided on the front and/or rear faces 38, 40 of the guard 22, for alignment with markings indicating a cut to be made.

In use of the saw 10, the guard 22 advances in a direction parallel to an axis of the saw (extending between the front and rear ends 14, 16) as the saw is plunged, and thus as the guard moves from the safety to the cutting position. This is clearly illustrated in FIG. 1, where it will be noticed that a gap 66 between the guard rear face 40 and the operating head 36 prior to plunging is greater than following plunging. In contrast, a gap 68 between the guard front face 38 and the operating head 36 following plunging is greater than prior to plunging.

Thus it will be seen that the guard 22 effectively advances several millimetres over the operating head 36, in the direction parallel to the saw axis, as the blade 20 is plunged, this advancement being accommodated by appropriate dimensioning of the guard 22. To facilitate movement of the guard 22 and, in particular, to allow for this movement of the guard 22 over the operating head 36, suitable slider bearings (not shown) may be provided between the guard and the operating head. Such slider bearings may, for example, be as taught in EP1177868.

Turning now to FIGS. 3 and 4, there are shown left side and rear views of a power tool in the form of a saw in accordance with an alternative embodiment of the present invention, the saw indicated generally by reference numeral 100. The saw 100 is of similar construction and operation to the saw 10 of FIGS. 1 and 2, and like components of the saw 100 with the saw 10 share the same reference numerals, incremented by 100. Only the substantive differences between the saws 10 and 100 will be described herein in detail.

The saw 100 is in fact of very similar construction to the saw 10, save that the saw 100 includes mounting brackets 150 and 152 which are larger than the brackets 50 and 52 of the saw 10. In this fashion, the pivot point 25 is brought closer to the surface in which a cut is to be formed. Additionally, arms 146 and 148 coupling a guard 122 of the saw 100 to a motor housing portion 134 are disposed at angles which are less inclined, relative to a base plate 126 of the guard 122. Accordingly, in use of the saw 100, lateral movement of the guard 122 (in a direction parallel to an axis extending between front and rear ends 114, 116) is reduced. The saw 100 therefore offers improved performance, in terms of control of the saw during cutting, over the saw 10. A further difference in the saw 100 is that the finger guards 56 and 58 of the saw 10 may be dispensed with, as a space 160 defined between the arms 146, 148 and the motor housing portion 134 is greater, with a reduced likelihood of the fingers of the operator being contacted by the arms.

Turning now to FIG. 5, there is shown a left side view of a power tool in the form of a saw in accordance with a further alternative embodiment of the present invention, the saw indicated generally by reference numeral 200.

The saw 200 is of similar construction and operation to the saw 10 of FIGS. 1 and 2, and like components of the saw 200 with the saw 10 share the same reference numerals, incremented by 200. Only the substantive differences between the saws 10 and 200 will be described herein in detail.

The saw 200 is in fact of very similar construction to the saw 10, save that the saw 200 includes different mounting brackets to the brackets 50 and 52 of the saw 10. One such bracket 250 is shown in FIG. 5, and it will be noted that the bracket defines an elongate aperture 70 in which a pivot pin 254 is received. It will be understood that the second bracket (not shown) of the saw 200 is provided with a similar such aperture, and that the pivot pin 254 is located extending through the aligned apertures. In this fashion, the pivot pin 254 may translate along a length of the apertures 70 between an advanced position shown in solid outline in FIG. 5, and a retracted position shown partially in broken outline.

When a blade 220 of the saw 200 is plunged into a workpiece surface, lateral movement of a guard 222 of the saw 200 is accounted for by movement of the pivot pin 254 from the advanced position (towards a front end of the aperture 70) to the retracted position (towards a rear end of the aperture 70). In this fashion, it is not necessary to provide large gaps between front and rear faces 238, 240 of the guard 222 and an operating head 236 of the saw 200, as is the case with the saw 10.

Turning now to FIG. 6, there is shown a left side view of a power tool in the form of a saw in accordance with a further alternative embodiment of the present invention, the saw indicated generally by reference numeral 300. The saw 300 is of similar construction and operation to the saw 10 of FIGS. 1 and 2, and like components share the same reference numerals incremented by 300. Only the substantive differences between the saws 10 and 300 will be described herein in detail.

The saw 300 is in fact of very similar construction to the saw 200 of FIG. 5, save that the saw 300 includes arms for mounting a guard 322 to a housing 312 of the saw 300 which are different to those of the saw 200. One such arm, which is a left arm of the saw 300, is shown in FIG. 6 and given the reference numeral 346. The arm 346 includes a first portion 72 which extends along a majority of a length of a motor housing portion 334, and a second portion 74 which is disposed at an angle (non-parallel) to the first portion 72. In this fashion, a larger space 360 is defined between the arms and the motor housing portion 334, in a similar fashion to the saw 100 described above. As with the saw 200, the saw 300 includes a mounting bracket 350 having an elongate aperture 350 in which a pivot pin 354 is received, offering similar advantages to those described above.

Turning now to FIGS. 7 and 8, there are shown left side and rear views of a power tool in the form of a saw in accordance with a further still alternative embodiment of the present invention, the saw indicated generally by reference numeral 400. The saw 100 is of similar construction and operation to the saw 10 of FIGS. 1 and 2, and like components of the saw 400 with the saw 10 share the same reference numerals, incremented by 400. Only the substantive differences between the saws 10 and 400 will be described herein in detail.

The saw 400 includes mounting brackets 450 and 452 which are elongated, alike to the brackets 150, 152 of the saw 100 shown in FIG. 3. However, the brackets are further elongated even than the brackets 150 and 152. In addition, the saw 400 includes two sets of mounting arms 446a, 448a and 446b, 448b respectively for mounting a guard 422 of the saw 400 to a housing 412 of the saw. The arms 446a, 448a are pivotally coupled to the mounting brackets 450 and 452 at a pivot point 425a by a respective pivot pin 454a. In a similar fashion, the second set of arms 446b, 448b are also pivotally coupled to the mounting brackets 450, 452 at a second pivot point 425b by a respective pivot pin 454b. The second pivot point 425b is spaced from the first pivot point 425a, but is similarly positioned rearwardly of a grip portion 424 of a handle 418 of the saw 400.

In addition, each set of arms 446a, 448a and 446b, 448b are pivotally coupled to the guard 422 via respective pivot pins 76a, 76b. In this fashion, the guard 422 is effectively mounted in a configuration which permits movement of the guard between safety and cutting positions with minimal (if any) angular movement of the housing 412 during plunging. This offers advantages in terms of control of the saw, and in terms of reduced lateral movement of the guard, in a similar fashion to that described above.

Turning finally to FIGS. 9 and 10, there are shown left side and rear views, respectively, of a power tool in the form of a saw in accordance with a yet further alternative embodiment of the present invention, the saw indicated generally by reference numeral 500.

The saw 500 is different in appearance to the saws 10 to 400 described above, however, the saw 500 is constructed and operates in a similar fashion to the previously described saws. Accordingly, like components of the saw 500 with the saw 10 of FIGS. 1 and 2 share the same reference numerals incremented by 500. Only the substantive differences between the saws 10 and 500 will be described herein in detail.

The saw 500 includes a housing 512 which is of different shape to the housing 12 of the saw 10. Specifically, the housing 512 includes a motor housing portion 534, a main axis of which is disposed, in use, parallel to the plane of a surface in which a cut is to be formed, and not inclined as is the case with the saw 10. Providing the housing 512 with the motor housing portion 534 in this shape and orientation facilitates positioning of the portion 534 closer to the surface to be cut, when compared to the saws 10 to 400.

The housing 512 also includes a handle 518 which is formed separately from the motor housing portion 534, and which is spaced from the portion 534 so as to define a space 78 in which the fingers of an operator reside. Furthermore, the handle 518 defines a grip portion 524 which is, again, disposed between front 514 and rear 516 ends of the saw 500. A switch 532 is provided in the space 78, by which the saw 500 is activated, and a depth adjuster knob 562 is provided which interacts with a depth adjuster scale 564.

A cutting blade 520 is mounted in a similar orientation to the blade 20 of the saw 10, and a guard 522 provided for enclosing the blade 520 when in a safety position. The guard 522 is pivotally coupled to the motor housing portion 534 by arms 546 and 548, coupled respectively to brackets 550, 552 through a pivot pin 554. Again, a pivot point 525 is located rearwardly of the handle grip portion 524.

In use of the saw 500, the blade 520 is plunged and urged through a slot in a base plate 526 of the guard 522, in the same way as the saw 10 blade 20. However, the different shape of the saw 500 housing 512, in particular the orientation of the motor housing portion 534, facilitates reduction of lateral displacement of the guard 522 without requiring elongate brackets or angled mounting arms as is the case with, for example, the saws 100 and 300.

Whilst the present invention has primarily been described and illustrated herein in relation to a plunge-type saw, having a cutting element in the form of a circular blade, it will be understood that the principles of the invention may be applied to a wide range of types of tool. For example, in alternative embodiments, a tool in the form of a planer having a cutting element in the form of a planer blade, may be provided. Alternative embodiments include different types of saws such as jigsaws and sanders.

Various modifications may be made to the foregoing without departing from the spirit or scope of the present invention.

For example, the features of one or more of the saws described above and illustrated in the accompanying drawings may be provided singly or in combination. Thus, in a particular alternative example, the saw 500 of FIG. 9 may have features corresponding to one or more of the saws 100, 200, 300 or 400 of FIGS. 3 to 8.

An aperture of a mounting bracket for a guard of the tool may have an aperture axis which is inclined relative to an axis of the housing, or the aperture may be arcuate such that the aperture axis lies on a curve.

Where the tool comprises a connector by which the guard is coupled to the housing, the connector may be curved.

1. A hand operated power tool comprising:
a housing having front and rear ends;
a handle on the housing, the handle having a grip portion disposed between the front and rear ends of the housing;
a cutting element provided towards the front end of the housing;
a motor mounted within the housing, a main axis of the motor lying substantially in the plane of the cutting element;
a guard mounted for movement relative to the housing between a safety position enclosing the cutting element and a cutting position in which the cutting element protrudes from the guard; and
wherein the guard is pivotally coupled to the housing, and wherein a point about which the guard pivots relative to the housing is positioned rearwardly of the handle grip portion and towards the rear of the housing.

2. A tool as claimed in claim 1, wherein the guard is coupled to the housing by an at least one connector.

3. A tool as claimed in claim 2, wherein the at least one connector is an elongate arm.

4. A tool as claimed in claim 2, wherein the guard is connected to the housing by two connectors, to provide the guard with a degree of torsional stiffness in its movement relative to the housing.

5. A tool as claimed in claim 2, wherein the connector is formed integrally with the guard.

6. A tool as claimed in claim 2, wherein the connector is provided as a separate component coupled to the guard.

7. A tool as claimed in claim 2, wherein the tool comprises a mounting portion extending from the housing, and wherein the guard is pivotally coupled to the mounting portion and thereby pivotally coupled to the housing, such that the mounting portion defines the point about which the guard pivots relative to the housing.

8. A tool as claimed in claim 7, wherein the mounting portion is shaped such that the pivot point is spaced a sufficient distance from the housing so as to define a space between the guard and the housing, the space being for receiving digits of the operator.

9. A tool as claimed in claim 8, wherein the space is defined between the housing and the at least one connector.

10. A tool as claimed in claim 1, wherein the guard is also slidably coupled to the housing, to facilitate movement of the guard generally in a direction parallel to an axis extending between the front end and the back end of the tool.

11. A tool as claimed in claim 7, wherein the housing comprises an elongate mounting aperture by which the guard is slidably coupled to the housing.

12. A tool as claimed in claim 11, wherein the aperture is defined by the mounting portion.

13. A tool as claimed in claim 11, wherein the aperture has an aperture axis, and wherein the aperture axis extends parallel to a main axis of the housing.

14. A tool as claimed in claim 11, wherein the aperture has an aperture axis, and wherein the aperture axis is inclined relative to a main axis of the housing.

15. A tool as claimed in claim 11, wherein the aperture has an aperture axis, and wherein the aperture is arcuate such that the aperture axis lies on a curve.

16. A tool as claimed in claim 10, when dependent on claim 2, wherein the guard is slidably coupled to the housing by the at least one connector.

17. A tool as claimed in claim 2, wherein the at least one connector is comprised of at least two portions disposed at non-parallel angles with respect to one-another, to thereby define a space between the at least one connector and the housing, the space being for receiving digits of the operator.

18. A tool as claimed in claim 2, wherein the at least one connector is curved, to thereby define a space between the at least one connector and the housing, the space being for receiving digits of the operator.

19. A tool as claimed in claim 1, wherein the guard is coupled to the housing such that during movement of the guard between the safety and cutting positions, an angle of the guard relative to the housing remains substantially constant.

20. A tool as claimed in claim 19, wherein the guard is coupled to the housing such that during movement of the guard between the safety and cutting positions, an angle of a base plate of the guard relative to the housing remains substantially constant.

21. A tool as claimed in claim 19, when dependent on claim 2, wherein an at least one connector is pivotally coupled at a first end to the guard and at a second opposite end to the housing, to facilitate such movement of the guard.

22. A tool as claimed in claim 1, wherein the housing is generally elongate, housing a motor for driving the cutting element and defining the handle such that the grip portion is formed on the part of the housing shaped to house the motor.

23. A tool as claimed in claim 1, wherein the housing comprises a portion housing a motor for driving the cutting element, and a separate portion defining the handle.

24. A tool as claimed in claim 1, wherein the tool is a plunge-saw having a cutting element in the form of a circular blade.

25. A tool as claimed in claim 1, wherein the tool is a planer having a planer blade.

26. A tool as claimed in claim 1, wherein the tool comprises a depth adjuster for governing the extent to which the cutting element protrudes through the guard when the guard is in the cutting position.

27. A hand operated power tool comprising:
a housing having front and rear ends;
a cutting element provided towards the front end of the housing; and a motor mounted within the housing, a main axis of the motor lying substantially in the plane of the cutting element;
a guard mounted for movement relative to the housing between a safety position enclosing the cutting element and a cutting position in which the cutting element protrudes from the guard; and
wherein the guard is pivotally coupled to the housing towards the rear end of the housing.

28. A hand operated power tool comprising:
a housing having front and rear ends;
a cutting element;
and a motor mounted within the housing, a main axis of the motor lying substantially in the plane of the cutting element;
a guard mounted for movement relative to the housing between a safety position enclosing the cutting element and a cutting position in which the cutting element protrudes from the guard; and
wherein the guard is pivotally coupled to the housing, and wherein a distance between the cutting element and the point about which the guard pivots relative to the housing is maximised.

29. A guard for a power tool, the guard being adapted to be mounted for movement relative to a housing of a power tool between a safety position enclosing a cutting element of the tool and a cutting position in which the cutting element protrudes from the guard;
wherein the guard is adapted to be pivotally coupled to the tool housing; and
wherein a point about which the guard is adapted to pivot relative to the housing is positioned rearwardly of a grip portion on a handle of the tool and towards the rear of the housing.
